(19) United States
(12) Patent Application Publication
(10) Pub. No.: US 2019/0266688 A1
(43) Pub. Date: Aug. 29, 2019

(54) DO-NO-HARM IOT DEVICE(S)

(71) Applicant: Bank of America Corporation, Charlotte, NC (US)

(72) Inventor: Sean Denton, Rock Hill, SC (US)

(73) Assignee: Bank of America Corporation, Charlotte, NC (US)

(21) Appl. No.: 15/907,687

(22) Filed: Feb. 28, 2018

(51) Int. Cl. G06Q 50/26; H04L 29/06; G06N 5/02

(52) U.S. Cl. CPC G06Q 50/265; G06N 5/02; H04L 63/1416

(57) ABSTRACT

A method of preventing constituent internet-connected IoT devices within a system from executing harmful procedures is provided. The method may include controlling each constituent device with a do-no-harm mode. The do-no-harm mode may include the definition of harm and the definition of harmful scenarios. A harmful scenario may include a scenario in which harm is being inflicted. A harmful scenario may also include a scenario in which there is a threshold likelihood that harm will be inflicted. The do-no-harm mode may also establish a plurality of contingency plans to execute when a constituent device is faced with one of a plurality of harmful scenarios. Each contingency plan may be designed to address at least one harmful scenario. Each of said plurality of contingency plans may either minimize the effects of the harmful scenario or terminate the harmful scenario entirely. The activation of the do-no-harm mode may prevent the constituent devices from inflicting harm.

### FIELD OF TECHNOLOGY

This application relates to Internet-of-Things (IoT) devices. Specifically, it relates to a system that prevents IoT devices from inflicting harm.

### BACKGROUND OF THE DISCLOSURE

Billions of devices worldwide are connected to the internet. These devices form the bulk of the Internet-of-Things (IoT). The complexity of these devices may range from very simple to highly sophisticated. An IoT device may be a machine that executes highly important tasks. An example may be an autonomous transport vehicle. The autonomous transport vehicle may be a car or bus, a boat, an aircraft, or a spacecraft. These transport vehicle IoT devices may be responsible for the lives of many human passengers. Another example of a highly critical IoT device may be a device with access to finances. These devices may be responsible for one or more individuals' wealth, or even the assets of one or more institutions.

The (IoT) devices may be connected to the internet. They may also have a connection to at least one other IoT device. These connections may allow communication between IoT devices. Some IoT devices may have a degree of control over one or more other IoT devices.

Considering the vast number of IoT devices, and the vast collective responsibility contained therein, a lot can go wrong. An IoT device may be caused to execute harmful activities. These activities may have far-reaching negative ramifications. The harmful activities may be caused by a bug in the device's system. The bug may cause the device to function in a manner the device was not designed to perform. Alternatively, the device may be functioning as designed, but an unforeseen circumstance may occur that threatens bodily harm or significant monetary damage. Another cause behind the harmful activity may be a malicious entity that gained illicit control of the device and is directing it to do harm.

It would thus be desirable for an IoT device to be prevented from inflicting harm.

### SUMMARY OF THE INVENTION

A system containing constituent devices, that protects its constituent devices from performing harm, is provided. The system may include at least one Internet-of-Things (IoT) device. The device may be coupled to the internet. The device may include a do-no-harm mode. The do-no-harm mode may prevent the device from inflicting harm. The do-no-harm mode may include the definition of harm and the definition of harmful scenarios. The do-no-harm mode may further contain appropriate contingency plans to execute when the device is faced with a harmful scenario. The contingency plans may minimize the harm or prevent the harm from occurring.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows another illustrative system in accordance with principles of the disclosure;

FIG. 3 shows another illustrative system in accordance with principles of the disclosure;

FIG. 4 shows a flowchart diagram in accordance with principles of the disclosure;

FIG. 5 shows another flowchart diagram in accordance with principles of the disclosure; and

FIG. 6 shows another flowchart diagram in accordance with principles of the disclosure.

### DETAILED DESCRIPTION OF THE DISCLOSURE

A system containing constituent devices, that protects its constituent devices from performing harm, is provided. The system may include at least one Internet-of-Things (IoT) device that is coupled to the internet. The IoT device may feature a do-no-harm mode to prevent the device from inflicting harm. The do-no-harm mode may define harmful scenarios. The do-no-harm mode may even define the concept of harm itself. The do-no-harm mode may provide contingency plans to execute when the device is faced with a harmful scenario. The do-no-harm mode may have control over the device, and direct the device to execute the contingency plan when the device is in a harmful scenario.

A harmful scenario may be a situation in which the device is already inflicting harm. A harmful scenario may also be a situation in which the device is likely to inflict harm. The do-no-harm mode may define the level of likelihood sufficient to qualify as a harmful scenario. A harmful scenario may even be a situation in which the device senses impending harm in its environs, such that the device may be capable of impeding that harm from occurring.

Harm may include bodily injury to a living organism. The living organism may be a human being. Harm may also include monetary loss to a human being.

A harmful scenario may include an autonomous vehicle in danger. The danger may be directed toward its occupants, and/or to people or property outside the vehicle. For example, a command to apply the gas and brakes simultaneously may cause the vehicle to lose control and crash. In another example, the vehicle may sense a person in its path of travel. In yet another example, an autonomous car, boat, aircraft, or spacecraft may be directed to travel into a perilous environment.

A harmful scenario may also include a device with access to finances. Some examples may include a smart card, smart watch, or mobile phone. It may be considered a harmful scenario if the device is directed to execute a suspicious activity. An example of suspicious activity may be to transfer the complete balance of an account. Suspicious activity may further include the transfer of funds from an account that leaves less than a predetermined threshold remaining in the account. The predetermined threshold may be a balance percentage, or a balance amount. The balance amount may be in dollars, or some other currency.

The harmful scenario may be caused by a variety of sources. A bug in the device's hardware or software may affect a departure from the parameters of normal functioning. Alternatively, the device may be functioning as designed, but an unusual circumstance may render the device harmful. For example, an autonomous car may be driving safely down a street, whereupon a person slips and falls into the car's path. The harmful scenario may also be caused by a malicious entity that gains control of the device. The malicious entity may direct the device to engage in destructive activity.

When the system senses that an IoT device is in a harmful scenario, the do-no-harm mode triggers a contingency plan. The contingency plan may be a simple command to cease all activity. A human user may be consulted for further instructions. The contingency plan may also include the execution of an alternative course of action that minimizes or prevents the harm.

The definitions of harm, harmful scenario, and appropriate contingency plans, may be pre-programmed in the do-no-harm mode. This may include a discrete list of harmful scenarios, and a mapping of each scenario to a specific contingency plan. The do-no-harm mode may also include a collection of requirements for not being harmful. When any of these requirements are not met, the device may be considered in a harmful scenario.

A preferred configuration of the do-no-harm mode may include Artificial Intelligence (AI) technology. The AI technology may incorporate Machine Learning (ML). The AI technology may contribute to the specification of the do-no-harm mode. The specification may include the definition of harm, harmful scenarios, and contingency plans for those harmful scenarios. The AI may periodically, or substantially continuously, refine aspects of the do-no-harm mode, as will be explained in more detail below.

Artificial Intelligence technology may provide a machine the ability to perform intelligent processes. Alan Turing famously defined a thinking machine as a machine that does as we thinking entities do. This may involve Machine Learning and Big Data (BD). Without AI and ML, a computer is provided an explicit set of directions to follow. This set of directions may be a computer program. ML is the process whereby a machine uses a data set without explicit instructions. The data set may be relatively large, and may be classified as Big Data. The machine analyzes the data and learns from it. This learning may be mathematically based, using statistics and probabilistic models. The machine may mathematically predict certain outcomes and consequences. The machine may use a feedback loop to further enhance its mathematical model based on its own experiences. A feedback loop may include the technique of continuously or periodically feeding new raw data into the beginning of the learning process. The new data may represent activities performed by, or on, the device itself. The new data may also include activities and/or physical properties non-related to the device or system. The new data may be sensed by the device itself. The new data may also be received as a communication by the device or system. The new data may be aggregated into the pool of raw data to be further analyzed, yielding a refined predictive model.

The do-no-harm mode in the disclosed system may use AI, ML, and/or Big Data. In some embodiments, AI, ML, or BD may require initial raw data points. These raw data points may represent histories of similar devices, or past history of the device or system itself. The system may augment this initial data with future data of its own.

The system may use AI and/or ML to analyze the data. The system may need to first process the raw data into a form appropriate for analysis. The appropriate form may include the way in which the data is categorized and represented. The appropriate form may also include the way in which the data is stored. The storage of the data may include data structures.

Even with AI, the system may require an initial definition of harm. In some embodiments, however, the system may use AI to construct the definition based on its own analytical process. The process may commence by flagging certain activities as statistically normal based on the data. By default, all other activities may be considered non-normal. The system may define a normal activity as acceptable, and a non-normal activity as unacceptable. An unacceptable activity may form an initial definition of harm. The system may substantially continuously refine and enhance the definition of harm based on feedback loops. The feedback loops may operate in response to data received in the future. The definition of harm may also be supplemented with other analytical techniques. For example, the do-no-harm mode may also define harm based on certain observed reactions to certain activities. For example, if an ambulance is summoned to the scene of a collision, the machine may conclude that a collision is harmful.

The system may also create models to predict what events and activities may lead to harm. For example, if colliding with an object has been classified as harmful, and in 95% of scenarios in which a car applied its brakes simultaneous with the throttle a collision ensued, that scenario may be defined as a harmful scenario. Based on other data, the system may learn that disengaging the throttle in the above scenario is likely to prevent the collision. This disengagement may then be defined by the system as an exemplary contingency plan.

The system may use any one of the many types of AI and ML learning. Some examples include Reinforcement Learning, Supervised Learning, and Unsupervised (Predictive) Learning.

The do-no-harm mode may initially be specified using data provided from outside the system. The provided data may be activity logs from other devices. The other devices may have at least one function in common with the devices in the system. The other devices may also be relatively similar, or even identical, to the devices in the system.

However, the do-no-harm mode may proceed to refine and enhance its definitions based on new data produced by the device itself. This process may use a feedback loop, and may continue throughout the lifetime of the device.

The system may include a plurality of IoT devices. Each device may include a do-no-harm mode. The devices may be interconnected as a network. The network topology may resemble any appropriate architecture, such as mesh, star, or ring. The system may be configured to require that, in order to join the system, a device must provide agreement to be controlled by a do-no-harm mode. In another embodiment, the system may not require a constituent device to be controlled by a do-no-harm mode.

The system may also use the data gathered from the IoT devices in the system to contribute to defining the do-no-harm mode. The system may be preferred to require that, in order to join the system, an IoT device must provide agreement to contribute data. In another embodiment, the system may not require a constituent device to contribute data. The data amassed from across the devices may be used in defining the do-no-harm mode. The translation of raw data into usable information for the do-no-harm mode may incorporate AI and/or ML. The analysis of a relatively large amount of data may include Big Data techniques. The access to Big Data may give the do-no-harm mode a powerful tool in accurately defining harm, harmful scenarios, and appropriate contingency plans.

A method of preventing constituent internet-connected IoT devices within a system from executing harmful procedures is provided. The method may include controlling each constituent device with a do-no-harm mode. The do-no-harm mode may include a definition of harm and a definition of harmful scenarios. A harmful scenario may include a scenario in which harm is being inflicted. A harmful scenario may also include a scenario in which there is a threshold likelihood that harm will be inflicted. The do-no-harm mode may also establish a plurality of contingency plans to execute when a constituent device is faced with one of a plurality of harmful scenarios. Each contingency plan may be designed to address at least one harmful scenario. Each of said plurality of contingency plans may either minimize the effects of the harmful scenario or terminate the harmful scenario entirely. The activation of the do-no-harm mode may prevent the constituent devices from inflicting harm.

In certain embodiments, the do-no-harm mode may define harm as bodily injury to a human being, or monetary loss to a human being. The do-no-harm mode may further define a harmful scenario as a device-initiated transfer of the complete balance, or a system defined threshold of the balance, out of a bank account that is connected to the system. The threshold may be a percentage of the balance, or alternatively a defined dollar amount.

In some embodiments, the method may include pre-programming the definitions of harm and harmful scenarios. The method may also include pre-programmed contingency plans. The method may further include pre-programming a mapping of said contingency plans to said harmful scenarios.

The method may further include interconnecting, within the system, a plurality of internet-coupled IoT devices to form a network. The method may include controlling each of said IoT devices with a do-no-harm mode. The method may further require that an IoT device must accede to control by a do-no-harm mode in order to join the network. In another embodiment, the method may not require a constituent device to be controlled by a do-no-harm mode.

The method may further include Artificial Intelligence (AI) technology. The AI may be used in conjunction with a set of data. The data may include a representation of IoT device activities from across the network. The method may use AI technology to construct mathematical models using the data. The AI may contribute to the specifying of the do-no-harm mode using the mathematical models. Specifying the do-no-harm mode may include defining harm and defining harmful scenarios. Specifying the do-no-harm mode may also include establishing contingency plans for the harmful scenarios. The method may further require that an IoT device must contribute data in order to join the system. The contributed data may be used in defining the do-no-harm mode. In another embodiment, the method may not require a constituent device to contribute data.

A system containing constituent devices that protects the environment around its constituent devices from harm is provided. The system may contain at least one Internet-of-Things (IoT) device coupled to the internet. The constituent IoT device may include a no-harm mode. The no-harm mode may control the device to prevent harm from occurring in its environs. The device's environs may include areas over which the device can have an effect. The no-harm mode may include contingency plans that prevent certain harms even at the expense of the device itself.

The no-harm mode may include a definition of harm and a definition of harmful scenarios. A harmful scenario may include a scenario in which harm is being inflicted. A harmful scenario may further include a scenario in which there is a threshold likelihood that harm will be inflicted. The no-harm mode may further include a plurality of contingency plans to execute when a device senses one of a plurality of harmful scenarios in its environment. Each contingency plan may be designed to address at least one harmful scenario. Each contingency plan may either minimize the effects of the harmful scenario or terminate the harmful scenario entirely.

As an example, the IoT device may be an unmanned autonomous drone. The drone may sense an incoming projectile that is on a course to hit and likely kill a nearby person. The no-harm mode may classify this as a harmful scenario and trigger a contingency plan. An exemplary contingency plan may include the drone intercepting the projectile. The interception may include interjecting itself into the path of the projectile. The device may do so even at the risk of self-destruction.

In one embodiment, the system may include an interconnected network of a plurality of internet-coupled IoT devices. Each IoT device may be under control of a no-harm mode. The system may further include the requirement that an IoT device must accede to control by a no-harm mode in order to join the network. In another embodiment, the system may not require a constituent device to be controlled by a no-harm mode.

The network of no-harm IoT devices may include Artificial Intelligence (AI) technology. The system may further include a set of data. The data may represent activities from the environs of IoT devices from across said network. The AI technology may construct mathematical models using the data. The AI may contribute to the specification of the no-harm mode using the mathematical models. The specification of the no-harm mode may include the definition of harm, and the definition of harmful scenarios. The specification may further include contingency plans for the harmful scenarios.

In one embodiment, the no-harm mode may restrict the device to act only on behalf of other devices in the system. In another embodiment, the no-harm mode may specify that the device prevent all harm to human beings. In yet another embodiment, the no-harm mode may request further instructions from a system supervisor. The system supervisor may be a human being.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

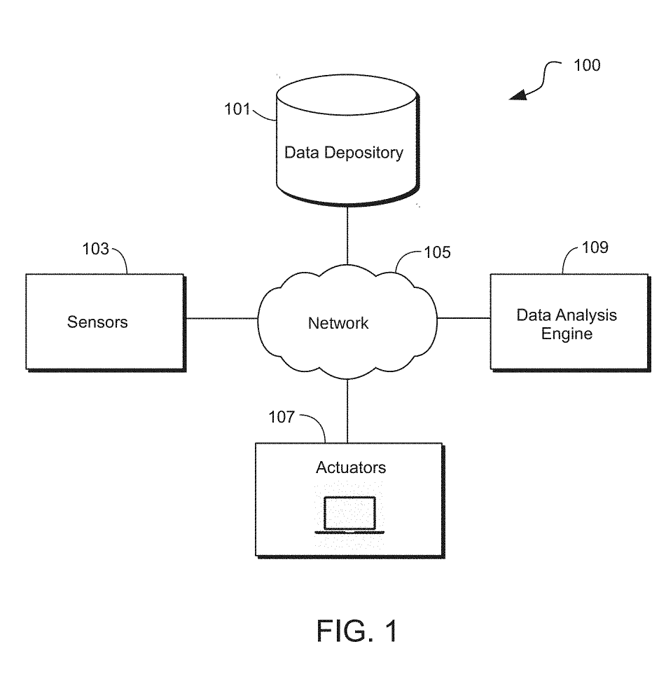

FIG. 1 shows illustrative system architecture 100. Architecture 100 may represent an internet of things (“IoT”). A differentiator between IoT and conventional networks is a traffic profile. In an IoT, nodes may not have defined or known network positions, communication protocols or security services.

Architecture 100 may include nodes. Each node may include two or more nodes. FIG. 1 shows exemplary nodes 101, 103, 105, 107 and 109. The architecture includes sensors 103. Sensors 103 may include devices that detect changes in a physical or virtual environment. For example, sensors may measure audio, rainfall, temperature or water levels. Sensors may measure electronic network traffic, electronic signals (e.g., input or output) or frequency of user logins from within a predefined geographic area.

Sensors may be any suitable size. For example, sensors may be a few millimeters in size. Sensors may be deployed in a wide variety of locations. For example, sensors may be deployed in military battlefields, industrial plants, in orchards, in clothing, automobiles, smart phones, jewelry or refrigerators. Sensors may be relatively inexpensive and have low energy consumption. Sensors may “sense” two or more stimuli or environmental changes.

Sensors may implement two or more functions. For example, sensors may measure changes in their native environment, capture data related to the measured changes store and communicate the captured data. Sensors may be accessed by other sensors or any other node. Sensors may transmit captured data to another node. Sensors may broadcast captured data to two or more nodes.

Captured data may be transmitted using any suitable transmission method. For example, data captured by a sensor may be extracted by a mobile phone. Sensors may leverage a communication link provided by a mobile phone to communicate captured data to another node.

Each sensor may be a node and each sensor may be assigned a unique identifier. For example, sensors may be identified by one or more radio frequency identification (“RFID”) tags. The RFID tag may be stimulated to transmit identity information about the sensor or any other information stored on the RFID tag.

Captured data may be transmitted by the sensor and processed far from the location of the sensor that captured the data. For example, captured data may be transmitted from one node to another node until the captured data reaches data repository 101.

Sensors maybe positioned and capture data from diverse locations. Locations may include geographic locations or virtual locations on electronic networks. Captured data may be transmitted to a location where information is needed for decisioning or consumption, which may not be the same place the data was captured or generated. Data synchronization protocols and caching techniques may be deployed to ensure availability of information at, or delivery to, a desired node. For example, a location where data is captured may not have continuous reliable network connectivity. Accordingly, captured data may be stored locally on the sensor for an amount of time prior to transmission or broadcast to another node.

Contextually, captured data may provide information not only about the physical environment surrounding a sensor, but the capturing of data from multiple sensors may provide data that signifies an event. Sensors may be grouped. Sensors may be grouped based on physical proximity or based on the content (or expected content) of data captured. Sensors may be grouped virtually. Other nodes, such as data analysis engine 109 may create and/or be included in such groups. In some embodiments, the captured data may be organized by data repository 101.

Based on data captured from sensors 103, actuators 107 may respond to a detected event. Based on the capture and analysis of multiple sources of data, actuators 107 may be instructed to take action without human intervention.

Generally, sensors and other nodes that form part of architecture 100 may include a processor circuit. The processor circuit may control overall operation of a node and its associated components. A processor circuit may include hardware, such as one or more integrated circuits that form a chipset. The hardware may include digital or analog logic circuitry configured to perform any suitable operation.

A processor circuit may include one or more of the following components: I/O circuitry, which may include a transmitter device and a receiver device and may interface with fiber optic cable, coaxial cable, telephone lines, wireless devices, PHY layer hardware, a keypad/display control device or any other suitable encoded media or devices; peripheral devices, which may include counter timers, real-time timers, power-on reset generators or any other suitable peripheral devices; a logical processing device, which may compute data structural information, structural parameters of the data, quantify indices; and machine-readable memory.

Machine-readable memory may be configured to store, in machine-readable data structures: captured data, electronic signatures of biometric features or any other suitable information or data structures. Components of a processor circuit may be coupled together by a system bus, wirelessly or by other interconnections and may be present on one or more circuit boards. In some embodiments, the components may be integrated into a single chip. The chip may be silicon-based.

The node may include RAM, ROM, an input/output (“I/O”) module and a non-transitory or non-volatile memory. The I/O module may include a microphone, button and/or touch screen which may accept user-provided input. The I/O module may include one or more of a speaker for providing audio output and a video display for providing textual, audiovisual and/or graphical output.

Software applications may be stored within the non-transitory memory and/or other storage medium. Software applications may provide instructions to the processor for enabling a node to perform various functions. For example, the non-transitory memory may store software applications used by a node, such as an operating system, application programs, and an associated database. Alternatively, some or all of computer executable instructions of a node may be embodied in hardware or firmware components of the node.

Software application programs, which may be used by a node, may include computer executable instructions for invoking user functionality related to communication, such as email, short message service (“SMS”), and voice input and speech recognition applications. Software application programs may utilize one or more algorithms that request alerts, process received executable instructions, perform power management routines or other suitable tasks.

As shown in FIG. 1, a node may operate in a networked environment. A node may be part of two or more networks. A node may support establishing network connections to one or more remote nodes. Such remote nodes may be sensors, actuators or other computing devices. Nodes may be personal computers or servers. Network connections may include a local area network (“LAN”) and a wide area network (“WAN”), and may also include other networks. When used in a LAN networking environment, a node may be connected to the LAN through a network interface or adapter. The communication circuit may include the network interface or adapter.

When used in a WAN networking environment, a node may include a modem or other circuitry for establishing communications over a WAN, such as the Internet. The communication circuit may include the modem.

The existence of any of various well-known protocols such as TCP/IP, Ethernet, FTP, HTTP and the like is presumed, and a node can be operated in a client-server configuration to permit a user to retrieve web pages from a web-based server. Web browsers can be used to display and manipulate data on web pages.

Nodes may include various other components, such as a battery, speaker, and antennas. Network nodes may be portable devices such as a laptop, tablet, smartphone, “smart” devices (e.g., watches, eyeglasses, clothing having embedded electronic circuitry) or any other suitable device for receiving, storing, transmitting and/or displaying relevant information.

A node may include a display constructed using organic light emitting diode (“OLED”) technology. OLED technology may enhance functionality of a node. OLEDs are typically solid-state semiconductors constructed from a thin film of organic material. OLEDs emit light when electricity is applied across the thin film of organic material. Because OLEDs are constructed using organic materials, OLEDs may be safely disposed without excessive harm to the environment.

Furthermore, OLEDs may be used to construct a display that consumes less power compared to other display technologies. For example, in a Liquid Crystal Display power must be supplied to the entire backlight, even to illuminate just one pixel in the display. In contrast, an OLED display does not necessarily include a backlight. Furthermore, in an OLED display, preferably, only the illuminated pixel draws power.

The power efficiency of OLED technology presents a possibility for designing nodes that provide enhanced security and functionality. Illustrative devices that may be constructed using OLED technology are disclosed in U.S. Pat. No. 9,665,818, which is hereby incorporated by reference herein in its entirety.

A node may be operational with numerous other general purpose or special purpose computing system environments or configurations. Examples of well-known computing systems, environments, and/or configurations that may be suitable for use with the invention include, but are not limited to, personal computers, server computers, handheld or laptop devices, tablets, “smart” devices (e.g., watches, eyeglasses, clothing having embedded electronic circuitry) mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Nodes may utilize computer-executable instructions, such as program modules, being executed by a computer. Generally, program modules include routines, programs, objects, components, data structures, etc. that perform particular tasks or implement particular abstract data types. A node may be operational with distributed computing environments where tasks are performed by remote processing devices that are linked through a communications network. In a distributed computing environment, program modules may be located in both local and remote computer storage media including memory storage devices. Nodes may rely on a network of remote servers hosted on the Internet to store, manage, and process data (e.g., “cloud computing”).

Nodes may include a battery. The battery may be a power source for electronic components of the node. For example, the battery may supply power to the display, the communication circuit and the processor circuit. In some embodiments, a node may include a plurality of batteries. Nodes may include solar panels that convert solar energy into electricity that powers one or more components of a node.

Sensors in a single architecture or other grouping may be produced by different manufacturers. Sensors may capture data in different formats. For example, sensors may use different data structures to package captured data. Sensors 103 may utilize different communication protocols to transmit captured data or communicate with other nodes. Despite such operational differences, sensors 103 may operate substantially seamlessly together. Interoperability may allow captured data to be substantially seamlessly captured and interpreted by data analysis engine 109. Based on interpreting the captured data, data analysis engine 109 may issue instructions to actuators 107.

Interoperability may be implemented across any suitable nodes of architecture 100. Interoperability may enable communication between sensors 103 and other nodes. Interoperability may enable architecture 100 to provide services and applications via actuators 107. Interoperability may allow services and content to be provided anywhere, anytime and based on input/output of different nodes.

Data gathering by one or more of sensors 103 may be controlled by one or more other nodes of architecture 100. For example, data analysis engine 109 may control a quantity of data captured by sensors 103. Alternatively, data repository 101 and/or analysis engine 109 may filter or otherwise intelligently process data captured by sensors 103.

Timing of when data is captured by sensors 103 may be controlled by any suitable node on architecture 100. For example, data may be captured in real-time or at pre-defined intervals such as once a day. Data may also be captured in response to a detected environmental status change.

Data analysis engine 109 may filter data captured by sensors 103. Data analysis engine 103 may repackage or reformat captured data. Data conversion may include transformation of low level raw data (possibly from multiple sensors or groups of sensors) into meaningful information for a target audience or for a target analysis.

For example, captured data intended for human consumption or interaction may be converted into a human understandable format. Captured data intended for machine consumption may be converted into a format readable by a particular machine or node.

Data analysis engine 109 may perform pattern recognition to identify correlations and trends in captured data. Data analysis engine 109 may also evaluate a cost of obtaining data. “Costs” may be monetary (e.g., labor costs or infrastructure costs), time-related or related to a level of intrusion needed to obtain desired data. “Costs” may be bandwidth-related.

For example, a communication link may be associated with a fixed bandwidth. The bandwidth may limit an amount of information or a rate of transmission over the communication link.

For example, a sensor may respond slowly to a request from another node if there is a large amount of informational traffic traveling on a communication link shared with other nodes. The large amount of informational traffic may not leave sufficient bandwidth for the transmitting node to timely communicate with the requesting node.

As a further example, a sensor may respond slowly if the sensor transmits a large amount of captured data. The large amount of information transmitted by the sensor, together with other informational traffic traveling on the shared communication link, may be close to, or exceed the bandwidth of the communication link. As a result, sensors may be unable to transmit captured date in a timely manner.

Data travelling within architecture 100 to/from nodes may be routed along multiple communication links until the transmitted information reaches a desired destination node (e.g., data analysis engine 109). Each communication link may service a number of connected nodes and a respective volume of informational traffic.

It may be difficult to ascertain available bandwidth on a particular communication link. It may be difficult to ascertain which communication links are being utilized to transmit information between nodes. Nodes attempting to transmit information over a communication link may not be aware of a number of connected nodes, a volume of traffic on a particular communication link or a bandwidth capacity of a communication link.

Furthermore, a communication link may be controlled by a different entity from an entity responsible for operation of a particular node. The entity responsible for operation of the node may be unable to monitor a number of nodes that share a communication link, a bandwidth capacity of a communication link or a volume of traffic transmitted on a communication link. Despite difficult to predict conditions on a communication link, it would be desirable for a node to timely respond to a request for information or timely receive desired information.

Sensors 103 may belong to, or operated by, different administrative/management domains. Sensors 103 may be operated by different domains without expressly-defined relationships among such domains. The absence of express relationships enables access to data captured by sensors 103 by one or more architectures having one or more features in common with architecture 100. Groups of sensors may include sensors from two or more administrative domains.

Data repository 101 may receive data captured by sensors 103. In some embodiments, data captured by sensors 103 may be transmitted directly to data analysis engine 109. Data stored in repository 101 may be sorted and analyzed by data analysis engine 109. Data stored in data repository 101 may be so voluminous and complex (e.g., structured/unstructured and/or constantly changing) that traditional data processing application software may be inadequate to meaningfully process the data (e.g., “big data”). Data analysis engine 109 may include software applications specially designed to process large volumes of data (“big data analytics”).

Based on captured data, data analysis engine 109 may optimize processes, reduce loss (e.g., fraud), improve customer understanding and targeting, increase automation, decrease latency in products and/or services provided by actuators 107 and identify new analytical models that may utilize data captured by sensors 103.

Architecture 100 may include one or more layers of software applications. Software applications may implement a variety of functions and provide varied services to nodes of architecture 100. Software applications running on data analysis engine 109 may submit requests to sensors 103 for retrieval of specific data to achieve a functional goal provided by actuators 107. Software applications may control data captured by sensors 103 or actions taken by actuators 107. Software applications may control a flow of information within architecture 100.

Software applications may be implemented on a node. A node may be an enterprise system or a “cloud” of computing devices. On device applications may be dependent on a specific hardware configuration. Such hardware requirements may preferably be minimal, such as an extension of the OS/firmware of the device. For example, illustrative software applications for sensors may include TinyOS, Linux, Contiki and RIOT.

Software applications may include middleware. Middleware may connect an operating system or database to other software applications. Middleware may configure and manage hardware such as sensors (e.g., to achieve a target functionality). Middleware may be responsible for aggregating data captured by sensors 103 and passing captured data to data repository 101 and/or data analysis engine 109.

Software applications may provide security services that mitigate threats to the integrity of data captured by sensors 103 or architecture 100 generally.

Actuators 107 may respond to data transmitted or processed by other nodes such as data analysis engine 109. Actuators 107 may include devices that modify the physical state of a physical entity. Actuators 107 may include devices that modify a virtual state of information. For example, actuators 107 may move (translate, rotate, etc.) physical objects or activate/deactivate functionalities of more complex ones. An actuator may dim a light bulb, open a door, change a temperature setting, authorize access to an automated-teller-machine (“ATM”) and/or any other suitable functionality. Actuators 107 may verify identities, trigger electronic payments, extend credit or debit accounts.

Within an intelligent networked system such as architecture 100, sensors 103 perform the functions of input devices—they serve as, for example, “eyes,” collecting information about their environment. In contrast, actuators 107 act as “hands,” implementing decisions based on data captured by sensors 103. A single node may include the functions of sensors and actuators.

Actuators 107 may communicate with data analysis engine 109 and sensors 103. Actuators 107 may include an application programming interface (“API”) for communicating with other nodes. Actuators 107 may communicate directly with other nodes using machine-to-machine (“M2M”) protocols. Illustrative M2M protocols may include MQ Telemetry Transport (“MQTT”). M2M includes communication between two or more objects without requiring direct human intervention. M2M communications may automate decision and communication processes for actuators 107.

In the absence of express relationships between sensors and the devices that access data captured by the sensors traditional approaches for managing trust, security naming, discovery, or other traditional network services may not be applicable or available.

Generally, nodes of architecture 100 may interact and cooperate using one or more interaction paradigms. Exemplary interaction paradigms include client-server and peer-to-peer interactions. Illustrative communication protocols may include HyperText Transfer Protocol (“HTTP”), Simple Object Access Protocol (“SOAP”), REpresentational State Transfer (“REST”) Constrained Application Protocol (“CoAP”) or SensorML.

As a result of the disparate nature of sensors 103, an architecture, such as architecture 100 incorporating sensors 103, may support a variety of communication protocols. Illustrative supported protocols may include IEEE 802.15.4 (“ZigBee”), IEEE 802.11, Bluetooth Low Energy (BLE), 3G and 4G and LTE. For example, ZigBee requires approximately 20 to 60 mW (for 1 mW transmission power, a range of 10 to 100 meters and a data transmission rate of 250 kbit/s).

To conserve energy, a sensor may communicate wirelessly for short periods of time. Utilizing this approach, one or more standard size single cell cylindrical dry battery batteries (e.g., AA size) may provide requisite computing power and wireless communication for many months.

Communication protocols used by nodes (e.g., sensors or actuators) may not have, or may not be capable of having, security capabilities. A security layer or buffer may be implemented by nodes that receive or rely on data captured by insecure sensors. Sensors or other nodes may be dynamically added or removed from an architecture. A security layer or buffer may be modular to scale quickly and meet growth/contraction requirements.

A physical layer may physically link nodes of architecture 100. The function of this physical layer is to provide communication pathways to carry and exchange data and network information between multiple sub-networks and nodes.

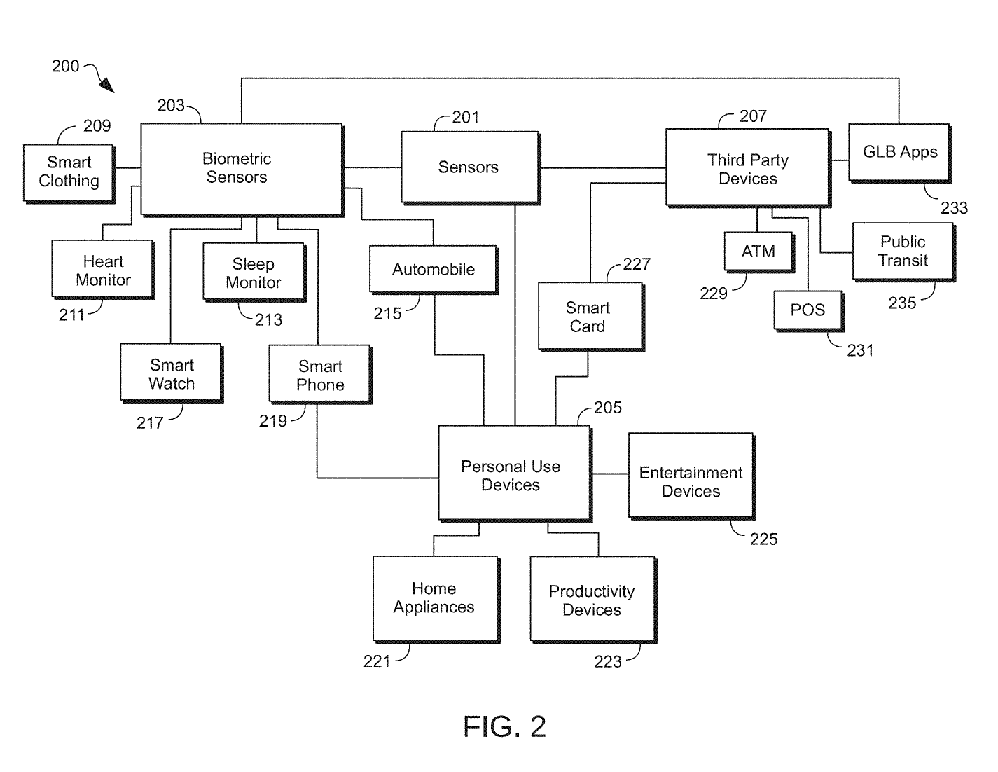

FIG. 2 shows illustrative sensors 200. Sensors 200 may include or more features of sensors 103 (shown in FIG. 1). Sensors 200 include biometric sensors 203 that sense biometric attributes. For example, biometric sensors may be embedded in “smart” clothing 209 that monitors a wearer's physical condition. Such clothing may capture biometric data, such as pulse rate, temperature, muscle contraction, heart rhythm and physical movement. Smart clothing may be linked to smart phone 219 such as via a Bluetooth® communication link. Smart phone 219 may transmit data captured by smart clothing 209 to one or more other network nodes.

Biometric sensors 203 may include other illustrative sensors such as heart monitor 211, sleep monitor 213, smart watch 219, smart phone 219 and automobile 215.

Sensors 200 may include personal use devices 205. Personal use devices 205 may include sensors embedded in home appliances 221, productivity devices 223 or entertainment devices 225. Productivity devices 223 may include tablets, laptops or other personal computing devices. Entertainment devices may include gaming consoles and the like.

Sensors 200 also include third-party devices 207. Third-party devices may include devices that are not under the direct or exclusive control of a user. A user may interact with third-party devices 207 to obtain a desired service provided by the third-party.

Exemplary third-party devices include smart card 227. Smart card 227 may function as a purchasing instrument. Illustrative purchasing instruments may conform to specifications published by the International Organization for Standardization. Such specifications may include: ISO/IEC 7810, ISO/IEC 7811 and ISO/IEC 7816, which are hereby incorporated herein by reference in their entireties. Suitable purchasing instruments may include a credit card, debit card and electronic purchasing devices. Such purchasing instruments may sense a location or frequency of use.

Such purchasing instruments may include “EMV” chips. EMV is a technology that derives its name from the companies (Europay, MasterCard, and Visa) that helped develop the technology. When the credit card and its associated EMV chip are inserted into a specialized card reader (another sensor), the reader powers the EMV chip and the EMV chip generates a new authorization code each time the credit card is used. The EMV chip may capture transaction data such as amounts, location or identity of the chip reader.

Third-party sensors 207 may include ATMs 229, point-of-sale terminals (“POS”) 231, and public transit 235. Such devices may also be actuators.

Third-party devices may also include software applications 233. Applications 233 may be used to access services, such as an online banking portal. Such applications may detect biometric features to authorize access to the online banking portal. Third-party devices may include sensors that capture data associated with power consumption (e.g., smart grids), electronic communication traffic, logistics (package movement) or any other suitable environmental condition.

FIG. 2 shows that sensors may categorically overlap. For example, an application used to access an online bank portal may capture a biometric feature (e.g., fingerprint) to authenticate a user.

Each of the sensors shown in FIG. 2 may include different and possibly incompatible hardware. For example, sensors may each have different operating systems (or none at all), processor types and memory. Sensors 200 may be inexpensive, single-function devices with rudimentary network connectivity. Sensors 200 may be positioned in remote and/or inaccessible locations where human intervention or configuration is difficult.

To conserve power, sensors 200 may utilize 16-bit microcontrollers. Such microcontrollers may use less than 400 μW per MIPS (“million instructions per second”) and may be capable of operating TCP/IPv6 stacks with 4 kB RAM and 24 kB flash memory. As outlined in proposed Internet standard RFC 4944, which is hereby incorporated by reference in its entirety, IPv6 may be implemented over IEEE 802.15.4 (e.g., ZigBee) based wireless communication standards.

Furthermore, because of potentially disparate features and characteristics of sensors 200, security solutions may be used to verify an authenticity of data transmitted by sensors having disparate hardware and software capabilities.

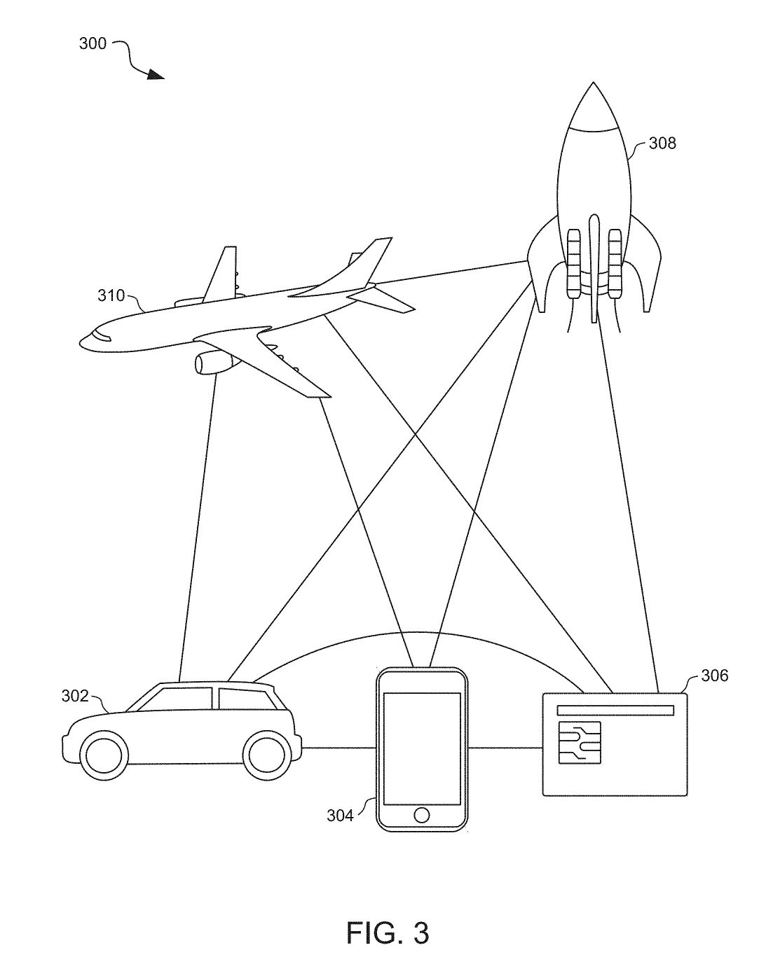

FIG. 3 shows an illustrative diagram according to certain embodiments of the disclosure. FIG. 3 is a schematic diagram of the architecture of a basic system 300. System 300 may include at least one IoT device. An IoT device may be in the form of an autonomous car 302, a mobile phone 304, or a smart-card 306. Other examples of an IoT device may include an autonomous spacecraft 308, or an autonomous aircraft 310. The autonomous aircraft 310 might be an unmanned drone, or a transport vehicle carrying people. The devices in the system may be fully interconnected with each other in a full mesh topology, as shown. The connections may be wireless, and may allow the devices to communicate with each other.

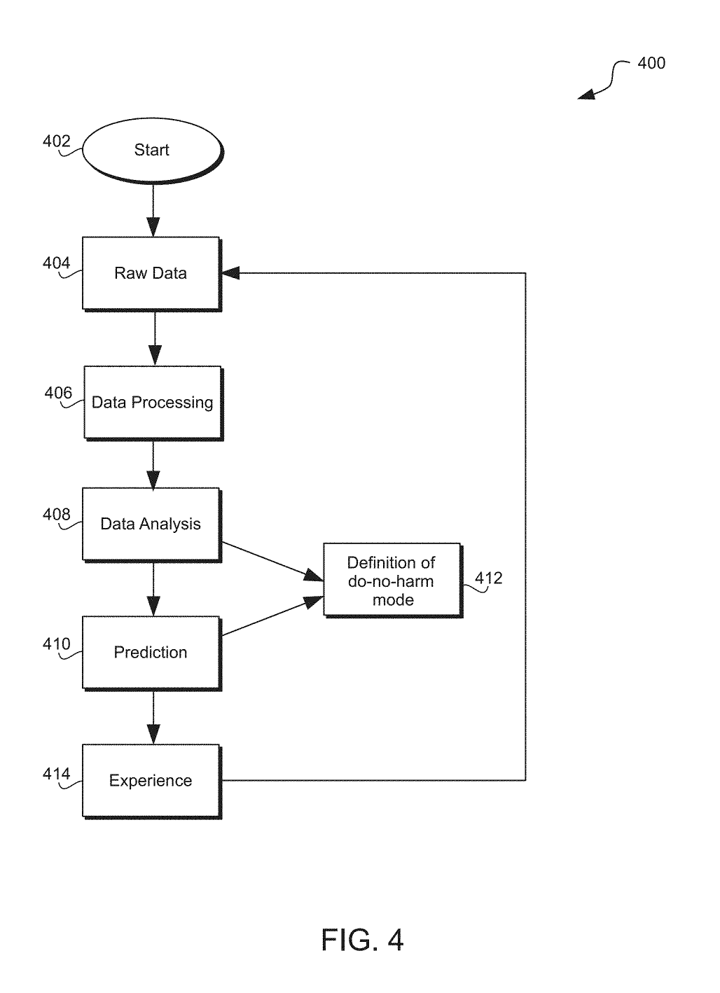

FIG. 4 shows a flowchart diagram in accordance with principles of the disclosure. Flowchart 400 may represent an AI or ML learning process. The learning process may include a feedback loop. At initiation of the process 402, the system contains raw data 404. The system may have been initialized with the raw data. The system may also generate raw data itself.

The next step in the process is data processing 406. In this step, the system transforms the raw data into a suitable format for AI or ML analysis. The next step is data analysis 408. At this step, the system uses AI or ML techniques to analyze the processed data and create conclusions.

The analysis techniques may include statistical and probabilistic methods. Some of the conclusions from step 408 may be used to make predictions 410. The predictions may present possible outcomes of certain activities or combinations of activities. The process then uses the conclusions from the data analysis 408, in conjunction with the predictions of 410, to define the do-no-harm mode 412. Do-no-harm mode 412 may be an initial definition. Do-no-harm mode 412 may also be a refinement of a pre-existing definition.

In the next step, which may be simultaneous with defining do-no-harm mode 412, the device records its experiences 414. The device may record all of the data it senses. Alternatively, the device may limit its record to data points relevant to the do-no-harm mode. The system may establish criteria for relevance. Once the device records new data, it may add the new data to the raw data of the system, 404. The process may then proceed again to 406, and on around the loop. This loop be a substantially continuous infinite cycle. Alternatively, the loop may be run periodically at system determined intervals.

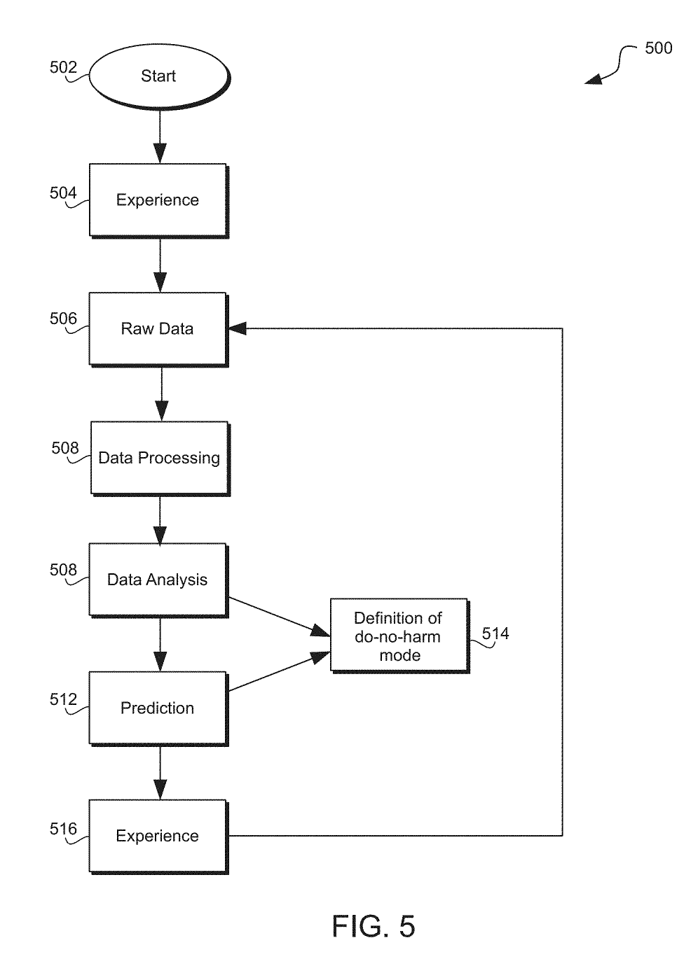

FIG. 5 shows another flowchart diagram in accordance with principles of the disclosure. Flowchart 500 may represent an AI or ML learning process. The process of flowchart 500 may be substantively similar to the process of flowchart 400 in FIG. 4. A feature that differentiates flowchart 500 from flowchart 400 may be step 504, device experience. In this embodiment of the AI or ML learning process, represented by flowchart 500, the system is not initiated with any raw data. The system should preferably generate the raw data on its own through sensing and recording its own experiences.

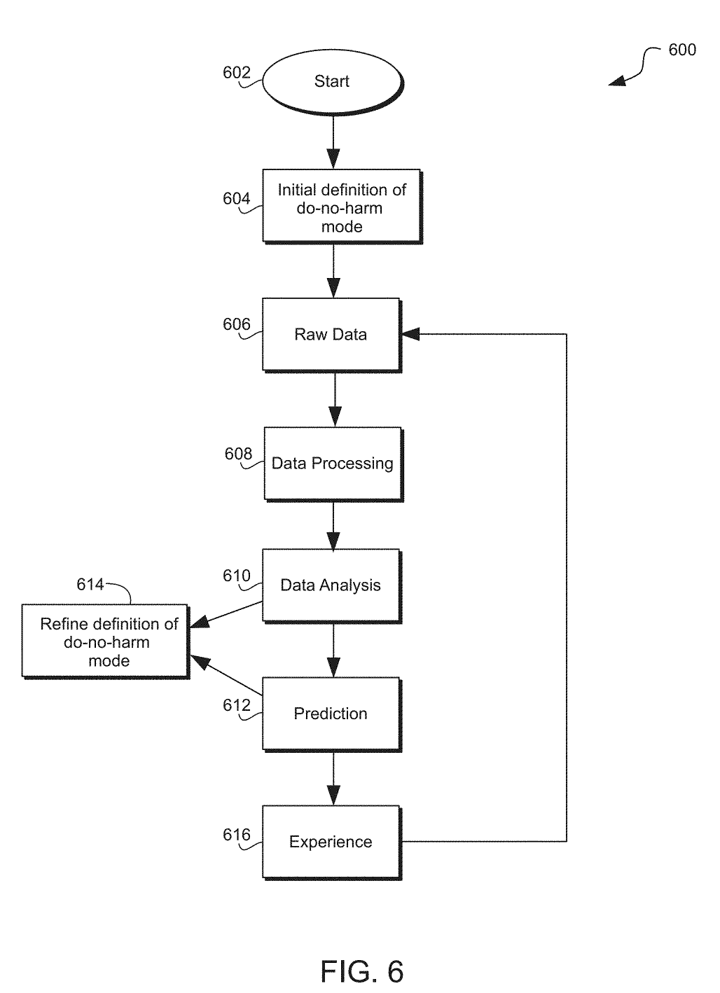

FIG. 6 shows another flowchart diagram in accordance with principles of the disclosure. Flowchart 600 may represent an AI or ML learning process. The process of flowchart 600 may be substantively similar to the process of flowchart 400 in FIG. 4. A feature that differentiates flowchart 600 from flowchart 400 may be step 604, the Initial Definition of the Do-No-Harm Mode. In this embodiment of the AI or ML learning process, represented by flowchart 600, the system is, at the beginning of its process, provided with an initial definition of a do-no-harm mode at step 604. As the learning process proceeds, the system refines the definition of the do-no-harm mode at step 614. Just as in step 412 in FIG. 4, the refinement at step 614 is based, at least in part, upon the outcomes of the Data Analysis 610 and Prediction 612.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and apparatus for a system containing constituent devices, that protects its constituent devices from performing harm, are provided. Persons skilled in the art will appreciate that the present invention can be practiced by other than the described embodiments, which are presented for purposes of illustration rather than of limitation, and that the present invention is limited only by the claims that follow.

What is claimed is:

1. A system comprising constituent devices that protects its constituent devices from performing harm, said system comprising:
at least one Internet-of-Things (IoT) device, said device coupled to the internet;
wherein said device comprises a do-no-harm mode, and said do-no-harm mode comprises control over the device and prevents it from inflicting harm;
said do-no-harm mode comprising the definition of harm and the definitions of a plurality of harmful scenarios;
each of said harmful scenarios comprising a scenario in which there is a threshold likelihood that harm will be inflicted by the device, or by signals generated by the device;
said do-no-harm mode further comprising a plurality of contingency plans to execute when the constituent device is in one of a plurality of harmful scenarios, each contingency plan designed to address at least one harmful scenario, wherein each of said plurality of contingency plans either minimizes the effects of the harmful scenario or terminates the harmful scenario entirely; and
wherein said do-no-harm mode has control over the device, and directs it to execute a contingency plan when the device is in a harmful scenario.

2. The system of claim 1, wherein said harm comprises bodily injury to a living organism.

3. The system of claim 2, wherein said living organism comprises a human being.

4. The system of claim 1, wherein said harm comprises monetary loss to a human being.

5. The system of claim 4, wherein said monetary loss comprises the device-initiated transfer of the complete balance, or a system defined threshold percentage of the balance, out of a bank account that is connected to said system.

6. The system of claim 1, wherein the do-no-harm mode comprises a security feature for a device compromised by a cyber-attack, and wherein harm comprises bodily injury or death to a human being, or monetary loss to a human being.

7. The system of claim 1, wherein said do-no-harm mode comprises pre-programmed definitions of harm and harmful scenarios, and further comprises pre-programmed contingency plans mapped to said harmful scenarios.

8. The system of claim 1, wherein said do-no-harm mode comprises Artificial Intelligence (AI) technology, and said system further comprises a set of data, said data comprising a representation of IoT device activities, wherein the AI technology uses the data to construct mathematical models, and said system uses said models to contribute to the specification of the do-no-harm mode, said specification comprising the definition of harm, and the definitions of a plurality of harmful scenarios, and said specification further comprising contingency plans for said harmful scenarios.

9. The system of claim 1, further comprising a network of interconnected internet-coupled IoT devices, each of said IoT devices comprising a do-no-harm mode.

10. The system of claim 9, wherein an IoT device must accede to control by a do-no-harm mode in order to join the system.

11. The system of claim 9, wherein said network of do-no-harm IoT devices comprises Artificial Intelligence (AI) technology, and said system further comprises a set of data, said data comprising a representation of IoT device activities from across said network, wherein the AI technology uses the data to construct mathematical models, and said system uses said models to contribute to the specification of the do-no-harm mode, said specification comprising the definition of harm, and the definition of harmful scenarios, and said specification further comprising contingency plans for said harmful scenarios.

12. The system of claim 11, wherein an IoT device must accede to contribute data in order to join the system, said data to be used in defining the do-no-harm mode.

13. A method of preventing constituent internet-connected IoT devices within a system from executing harmful procedures, said method comprising:
controlling each constituent device with a do-no-harm mode;
defining, in said do-no-harm mode, the definition of harm and the definition of each of a plurality of harmful scenarios, each of the plurality of harmful scenarios comprising a scenario in which there is a threshold likelihood that harm will be inflicted by a constituent device;
further defining, in said do-no-harm mode, one or more contingency plans to be executed when a constituent device is faced with one of a plurality of harmful scenarios, each contingency plan designed to address at least one harmful scenario, each of said contingency plans either mitigating the effects of the harmful scenario or terminating the harmful scenario entirely; and
executing, by the direction of the do-no-harm-mode, a contingency plan when a constituent device is in a harmful scenario.

14. The method of claim 13, further comprising defining said harm as bodily injury or death to a human being, or monetary loss to a human being.

15. The method of claim 14, further comprising defining a harmful scenario as the device-initiated transfer of the complete balance, or the complete balance minus a system defined threshold monetary amount, out of a bank account that is connected to said system.

16. The method of claim 13, further comprising pre-programming the definitions of harm and harmful scenarios, further comprising pre-programmed contingency plans, and further comprising pre-programming a mapping of said contingency plans to said harmful scenarios.

17. The method of claim 13, further comprising interconnecting within the system a plurality of internet-coupled IoT devices to form a network, controlling each of said IoT devices with a do-no-harm mode, further requiring that an IoT device must accede to control by a do-no-harm mode in order to join the network, said network of do-no-harm IoT devices comprising Artificial Intelligence (AI) technology, said system further comprising a set of data, said data comprising a representation of IoT device activities from across said network, said AI technology constructing mathematical models using said data, said system contributing to the specifying of the do-no-harm mode using said models, said specifying comprising the defining of harm, and the defining of harmful scenarios, and said specifying further comprising establishing contingency plans for said harmful scenarios.

18. The method of claim 17, further requiring that an IoT device must accede to contribute data in order to join the system, said data to be used in defining the do-no-harm mode.

19. A system comprising constituent devices that protects the environment around its constituent devices from harm, said system comprising:
at least one Internet-of-Things (IoT) device, said device coupled to the internet;
wherein said device comprises a no-harm mode, wherein said no-harm mode comprises control of the device and prevents harm from occurring in its environs;
said environs comprising areas that the device can affect;
said no-harm mode comprising the definition of harm and the definition of a plurality of harmful scenarios;
said harmful scenarios comprising scenarios in which there is a threshold likelihood that harm will be inflicted;
said no-harm mode further comprising a plurality of contingency plans to execute when a device senses one of a plurality of harmful scenarios in its environment, each contingency plan designed to address at least one harmful scenario; and
each of said plurality of contingency plans that either mitigates the effects of the harmful scenario or terminates the harmful scenario entirely.

20. The system of claim 19, further comprising an interconnected network of a plurality of internet-coupled IoT devices, each of said IoT devices under control of a no-harm mode, further comprising the requirement that an IoT device must accede to control by a no-harm mode in order to join the network, said network of no-harm IoT devices comprising Artificial Intelligence (AI) technology, said system further comprising a set of data, said data comprising a representation of activities from the environs of IoT devices from across said network, wherein said AI technology constructs mathematical models using said data, and said system contributes to the specification of the no-harm mode using said models, said specification comprising the definition of harm, and the definition of harmful scenarios, and said specification further comprising contingency plans for said harmful scenarios.
